(19) United States
(12) Patent Application Publication
(10) Pub. No.: US 2025/0322359 A1
(43) Pub. Date: Oct. 16, 2025

(54) Computing Platform and Method for Establishing a Collaborative Relationship Between Parties Involved on a Construction Project

(71) Applicant: Procore Technologies, Inc., Carpinteria, CA (US)

(72) Inventors: Sarah Shiroma, Austin, TX (US); Wilfredo Merced, Austin, TX (US)

(21) Appl. No.: 18/633,047

(22) Filed: Apr. 11, 2024

(51) Int. Cl. G06Q 10/10; G06Q 50/08

(52) U.S. Cl. CPC G06Q 10/103; G06Q 50/08

(57) ABSTRACT

A computing platform configured to: (i) receive, from a primary collaborator, a request to create an invitation for a secondary collaborator to collaborate on a construction project, wherein the primary collaborator has created a project workspace for the construction project within software application, the request including a first set of collaboration information comprising (a) an identification of the secondary collaborator and (b) an identification of permission templates, (ii) based on the request, cause the invitation to be presented to the secondary collaborator, (iii) receive, from the secondary collaborator, a response to the invitation including a second set of collaboration information comprising an identification of users associated with the secondary collaborator to be granted access to the project workspace, and (iv) based on the first and second sets of collaboration information, enable each identified user to access the project workspace in accordance with a respective permission template.

### BACKGROUND

Construction projects are often complex endeavors involving the coordination of many professionals across several discrete phases. Such projects have multiple planning and building phases that occur and require lengthy communication. The planning phases may involve contract bidding, contractor selection, project feasibility studies, regulatory approval and/or permitting, among other known planning phases.

Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well.

After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction or implementation phase, construction professionals begin to construct the project based on the finalized plans.

Such construction planning, design, and implementation may involve various different parties, including an architect, a general contractor, and one or more subcontractors, among other examples. Software technology has been developed to enable electronic management of information associated with a construction project, which includes documenting events and information associated with the various parties involved with a construction project.

### SUMMARY

Disclosed herein is the new technology for establishing a collaborative relationship within a construction management software application between two different parties involved in a construction project.

In one aspect, the disclosed technology may take the form of a method that involves (i) receiving, from a primary collaborator, a request to create an invitation for a secondary collaborator to collaborate on a construction project within a construction management software application, wherein the primary collaborator has created a project workspace for the construction project within the construction management software application, and wherein the request to create the invitation includes a first set of collaboration information including at least (a) an identification of the secondary collaborator and (b) an identification of one or more permission templates that are available for assignment to users associated with the secondary collaborator, (ii) based on the received request, causing the invitation to be presented to the secondary collaborator, (iii) receiving, from the secondary collaborator, a response to the invitation to collaborate on the construction project within the construction management software application, wherein the response to the invitation includes a second set of collaboration information including at least an identification of one or more users associated with the secondary collaborator that are to be granted access to the project workspace for the construction project, and (iv) based on the first set of collaboration information and the second set of collaboration information, enabling each of the identified one or more users associated with the secondary collaborator to access the project workspace in accordance with a respective permission template that is selected from the one or more permission templates identified by the first collaborator.

In some example embodiments, the second set of collaboration information may further include, for each of the one or more identified users associated with the secondary collaborator that are to be granted access to the project workspace, an identification of a respective permission template for the identified user that is selected by the secondary collaborator from the one or more permission templates.

Further, in some example embodiments, the function of enabling each of the identified one or more users associated with the secondary collaborator to access the project workspace in accordance with the respective permission template that is selected from the one or more permission templates identified by the first collaborator may take various forms. As one example, the function may involve assigning each of the identified one or more users associated with the secondary collaborator the respective permission template for the identified user that is selected by the secondary collaborator from the one or more permission templates. As another example, the function may involve assigning each of the identified one or more users associated with the secondary collaborator a respective permission template from the one or more permission templates that is associated with respective project role of the identified user that is input by the secondary collaborator.

Further yet, in some example embodiments, the first set of collaboration information may further include a universe of project roles that may be available for assignment to users associated with the secondary collaborator. And in some example embodiments, the one or more permission templates may each be associated with a respective project role. Further yet, in some example embodiments, the second set of collaboration information further includes, for each of the one or more identified users associated with the secondary collaborator that are to be granted access to the project workspace, an identification of a respective project role of the identified user that is input by the secondary collaborator.

Further yet, in some example embodiments, the method may further involve receiving, from the primary collaborator, a third set of collaboration information that includes an approval, rejection, or modification of the request to the invitation to collaborate on the construction project.

In another aspect, the disclosed technology may take the form of a computing system including at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium including program instructions stored thereon that are executable to cause a computing system to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 depicts an example network environment in which example embodiments may be implemented.

FIG. 2A depicts a flow diagram of an example process that may be carried out in accordance with the disclosed software technology for creating a collaboration invitation for a construction project.

FIG. 2B depicts a flow diagram of an example process that may be carried out in accordance with the disclosed software technology for responding to a collaboration invitation for a construction project.

FIG. 2C depicts a flow diagram of an example process that may be carried out in accordance with the disclosed software technology for reviewing a response to a collaboration invitation for a construction project.

FIG. 3A depicts an example screenshot of an interface that may be presented in accordance with the disclosed software technology for inviting collaborators to collaborate on a construction project.

FIG. 3B depicts an example screenshot of an interface that may be presented in accordance with the disclosed software technology for inviting collaborators to collaborate on a construction project.

FIG. 3C depicts an example screenshot of an interface that may be presented in accordance with the disclosed software technology for inviting collaborators to collaborate on a construction project.

FIG. 4A depicts an example screenshot of an interface that may be presented in accordance with the disclosed software technology for viewing an invitation to collaborate on a construction project.

FIG. 4B depicts an example screenshot of an interface that may be presented in accordance with the disclosed software technology for viewing an invitation to collaborate on a construction project.

FIG. 5 depicts an example screenshot of an interface that may be presented in accordance with the disclosed software technology for reviewing a response to an invitation to collaborate on a construction project.

FIG. 6 depicts an example computing platform that may be configured to carry out one or more of the functions of the present disclosure.

FIG. 7 depicts an example client device that may be configured to carry out one or more of the functions of the present disclosure.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. A person of ordinary skill in the art should understand that such references are for the purpose of explanation only and are therefore not meant to be limiting. Part or all of the disclosed platforms, devices, and methods may be rearranged, combined, added to, and/or removed in a variety of manners, each of which is contemplated herein.

Construction management today is often performed through the use of software applications, such as the software application provided by Procore Technologies, Inc.® (“Procore”), the applicant of the present disclosure. These software applications generally provide users the ability to create, store, view, and/or interact with various types of data related to a construction project, such as schedules, daily logs, images, drawings, specifications, building information models (BIMs), sensor data, budgets, change orders, communications, invoices, directories, punch lists, timesheets, requests for information (RFIs), submittals, and/or reports, among other types of data.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. As another possible implementation, a construction management software application may include front-end client software that runs on client devices without interaction with a back-end platform. These software applications may take other forms as well.

In general, such front-end client software may provide parties involved in a construction project with tools for performing and managing various tasks related to the construction project. Further, such front-end client software may take various forms, examples of which may include a native application (e.g., a mobile application) and/or a web application running on a client device, among other possibilities.

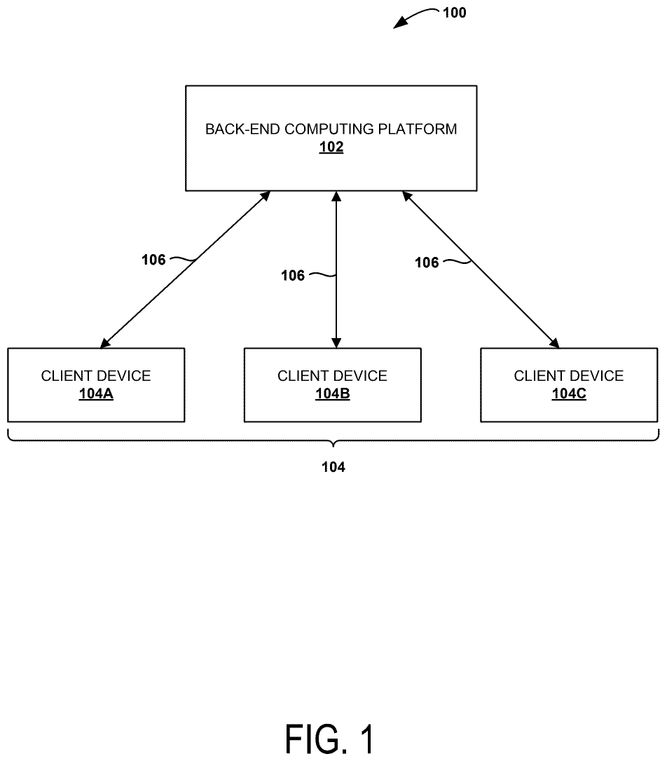

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each communication path 106 between the back-end computing platform 102 and one of the client devices 104 may generally comprise one or more communication networks and/or communications links, which may take any of various forms. For instance, each respective communication path 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

In line with the discussion above, existing construction management software applications may enable users to electronically manage construction projects, which may involve software features for creating, storing, viewing, and/or interacting with various types of data objects that memorialize information related to the construction project. These data objects could take various forms, examples of which may include RFI data objects, Daily Log data objects, Invoice data objects, and/or Timesheet data objects, among various other examples. Further, in at least some implementations, the software features for creating, storing, viewing, and/or interacting with the various types of data objects may optionally be arranged into different software “tools” that each correspond to a different type (or category) of data object. For instance, a construction management software application may include an “RFIs” tool for creating, storing, viewing, and/or interacting with RFI data objects, a “Daily Log” tool for creating, storing, viewing, and/or interacting with Daily Log data objects, and so on. However, in other implementations, the software features for creating, storing, viewing, and/or interacting with the various types of data objects may be arranged in other manners that are not based on software tools paradigm.

In operation, existing construction management software applications may enable a representative of a given party to (i) create an account with a construction management software application and (ii) add a set of individuals associated with the given party as users on the given party's account. After the given party's account is created and a set of users have been added, the construction management software application may thereafter enable the representative of the given party (or some other representative that has been added to the account as a user having the requisite permissions) to (i) create a respective project workspace for each of one or more construction projects that involve the given party and (ii) for each such construction project, designate a respective subset of the given party's users that are allowed to access data associated with the respective project workspace. In this respect, the given party may be considered to be the “owner” of the project workspace(s) and the data contained therein.

Along with adding the set of users to the given party's account and designating the respective subsets of users for the project workspaces, the construction management software application may further enable the representative of the given party (or some other representative that has been added to the account as a user having the requisite permissions) to define different permissions for such users, which may either be specific to each respective project workspace to which the users have been added (i.e., project-level permissions) or may be global to all project workspaces (i.e., account-level permissions). In practice, such permissions may be defined in terms of the types of data objects that can be accessed, the types of software features that can be utilized by the user, and/or the extent of access granted with respect to data object and/or software features (e.g., read/write access, read-only access, etc.) among other possibilities.

As one example to illustrate, a first user with a first set of permissions may have permission to access software features and data objects related to budgeting and invoicing, whereas a second user with a second set of permissions may not have permission to access these software features and data objects, but may instead have permission to access other types of software features and data objects (e.g., software features and data objects related to incidents and inspections).

As another example to illustrate, a first user with a first set of permissions may have a “read only” level of access with regards to certain data objects and software features, a second user with a second set of permissions may have a “read/write” level of access with regards to certain data objects and software features, and a third user with a third set of permissions may have an “admin” level of access with regards to certain data objects and software features that allows the third user to carry out read/write actions as well as other actions that go beyond those permitted by other levels of access, such as deleting data objects created by other users, adding users to a project workspace, and the like.

The representative of the given party (or some other representative that has been added to the account as a user having the requisite permissions) may define the permissions for the users in various ways. As one possibility, the representative of the given party may assign permissions at a user level, in which case the respective permissions that are assigned to a given user are applicable to any of the various types of data objects and sets of software features supported by the construction management application. As another possibility, the representative of the given party may assign permissions to each user on a more granular level, such as by assigning different permissions for different types of data objects and/or different sets of software features (e.g., different tools), in which case the respective permissions that are assigned to a given user may differ for different types of data objects and/or different sets of software features. Various other possibilities may also exist.

There may be times when one party involved in a construction project (e.g., a general contractor) may desire to collaborate with one or more other parties involved in the construction project (e.g., subcontractors) using a construction management software application such as the ones describes above. To illustrate with an example, a general contracting company called “Steven's Structural Solutions” may be working on a construction project to renovate Chicago's City Hall and may be using a construction management software application (such as Procore's construction management software application) to electronically manage that construction project. Steven's Structural Solutions may also be working on the Chicago City Hall Renovation construction project with “Moore's Floors and More” (e.g., to have them do flooring tasks), and the ability to collaborate with Moore's Floors and More through the same construction management software application would provide various advantages-including the ability to view and interact with data objects that are created and stored by Moore's Floors and More and the ability to receive input from Moore's Floors and More on data objects that are created and stored by Steven's Structural Solutions. However, construction management software applications currently offer limited options, if any, for allowing different parties (e.g., different construction companies) to collaborate with one another through the software applications in a logical and secure manner.

For instance, Procore's existing construction management software application may enable Steven's Structural Solutions to add an employee of Moore's Floors and More as a user to its account and then to the project workspace for the Chicago City Hall Renovation construction project owned by Steven's Structural Solutions, which would then allow Steven's Structural Solutions to collaborate with the employee of Moore's Floors and More through Procore's existing construction management software application. However, this approach has several drawbacks. First, this approach requires Steven's Structural Solutions to identify the appropriate employees of Moore's Floors and More to add to its account and then add those employees as users one by one, which may be inefficient and prone to error, particularly given that Steven's Structural Solutions may only have limited access to information about the employees of Moore's Floors and More. Second, Steven's Structural Solutions may only be permitted to add a limited number of users to its account and/or may have to pay increased fees when adding new users, which inhibits Steven's Structural Solutions' ability to add employees of Moore's Floors and More as users of its account. Third, once employees of Moore's Floors and More are added as users to Steven's Structural Solutions' account, those employees may then be permitted to engage in certain actions on the account and/or may be given access to certain data objects and/or software features that are not desirable for external parties. Adding individuals from one party as users of another party's account may give rise to other problems as well.

To address these and other problems with existing construction management software applications, disclosed herein is new software technology for establishing a collaborative relationship within a construction management software application between two different parties involved in a construction project, which may be referred to herein as the “primary collaborator” and the “secondary collaborator.” In this respect, the primary collaborator may comprise any party that has an account with a construction management software application and is using the construction management software application to manage a given construction project, e.g., by creating and managing a project workspace for the given construction project within the construction management software application, and the secondary collaborator may comprise any party with which the primary collaborator wishes to collaborate through the construction management software application on the given construction project, e.g., by adding users associated with the secondary collaborator to the project workspace for the given construction project owned by the primary collaborator. In other words, the primary collaborator may be the party that “owns” the project workspace and the data contained therein, and the secondary collaborator may be a party who has been added as a collaborator to the project workspace. In accordance with the present disclosure, a back-end computing platform associated with a construction management software application may carry out various functionality in order to facilitate the process of establishing a collaboration relationship.

First, the back-end computing platform may provide a first user interface that enables a representative of a primary collaborator to input a request to create an invitation for a secondary collaborator to collaborate on a given construction project through the construction management software application, which may be referred to herein as a “collaboration invitation.” Such a collaboration invitation may include various types of collaboration information, including but not limited to an identification of the given construction project, an identification of the secondary collaborator, and perhaps also an identification of one or more permission templates that are available for use in assigning permissions to the secondary collaborator's to-be-added users, where each such permission template comprises a respective set of permissions that defines what actions a user can take with respect to data objects and/or software features for the project workspace in terms of the types of data objects that can be accessed, the types of software features that can be utilized by the user, and/or the extent of access granted with respect to data object and/or software features (e.g., read/write access, read-only access, etc.) among other possibilities. Based on such a request that is received via the first user interface, the back-end computing platform may create the collaboration invitation for the given construction project and cause a notification of the collaboration invitation to be presented to the secondary collaborator.

Second, the back-end computing platform may provide a second user interface that enables a representative of the secondary collaborator to input a response to the collaboration invitation for the given construction project, which may involve identifying individuals associated with the secondary collaborator (sometimes referred to herein as “members” of the secondary collaborator) that are to be added as users to project workspace for the given construction project and perhaps also providing other information about the identified individuals that can be used to facilitate the assignment of permissions to the individuals, such as a selection of previously-identified permission templates and/or an identification of project roles for the individuals that are used together with previously-identified permission templates to automatically assign permissions to user, among other things.

Third, the back-end computing platform may provide a third user interface that enables a representative of the primary collaborator to review the secondary collaborator's response to the collaboration invitation (e.g., the to-be-added users) and optionally input any additional information that may be needed to establish the collaboration relationship. For instance, in a scenario where the primary collaborator did not previously identify any permission template(s) for use in assigning permissions to the secondary collaborator's to-be-added users and the secondary collaborator did not input any permission templates for its to-be-added, the third user interface may enable the representative of the primary collaborator to input permission settings (e.g., permission templates) for the individuals associated with the secondary collaborator that are to be added as users to the project workspace for the given construction project.

Fourth, based on the collaboration information input via the first user interface, the second user interface, and perhaps also the third user interface, the back-end computing platform 102 may establish a collaborative relationship within the construction management software application between the primary collaborator and the secondary collaborator for the given construction project—which may involve various operations. One operation may involve adding the identified individuals associated with the secondary collaborator as users to the project workspace for the given construction project. Another operation may involve assigning a respective permission template to each individual associated with the secondary collaborator that is added as a user to the project workspace for the given construction project based on the permission information provided via the first, second, and/or third user interface. Various other operations may also exist.

Once the collaborative relationship between the primary collaborator and the secondary collaborator has been established, the primary collaborator's users and the secondary collaborator's added users may be able to collaborate with one another on the given construction project within the construction management software application. For instance, the primary collaborator's users may thereafter have the ability to view and interact with data objects for the project workspace that are created and stored by the secondary collaborator's added users, and the secondary collaborator's added users may thereafter have the ability view and interact with data objects for the project workspace that are created and stored by the primary collaborator's users, among other things.

Advantageously, this software technology for establishing a collaborative relationship within a construction management software application between a primary collaborator and a secondary collaborator overcomes several of the drawbacks with existing construction management software applications that are discussed above.

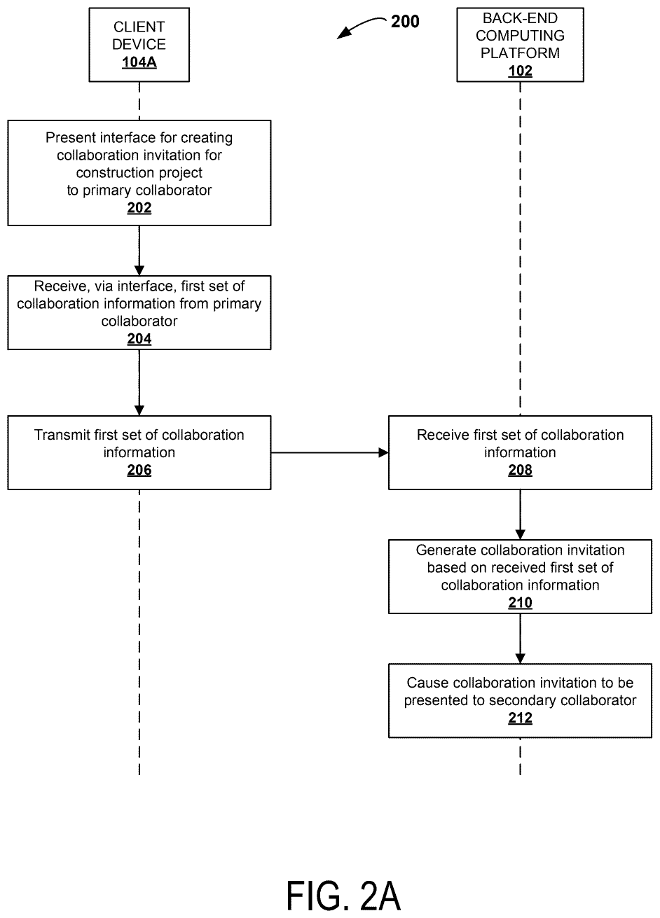

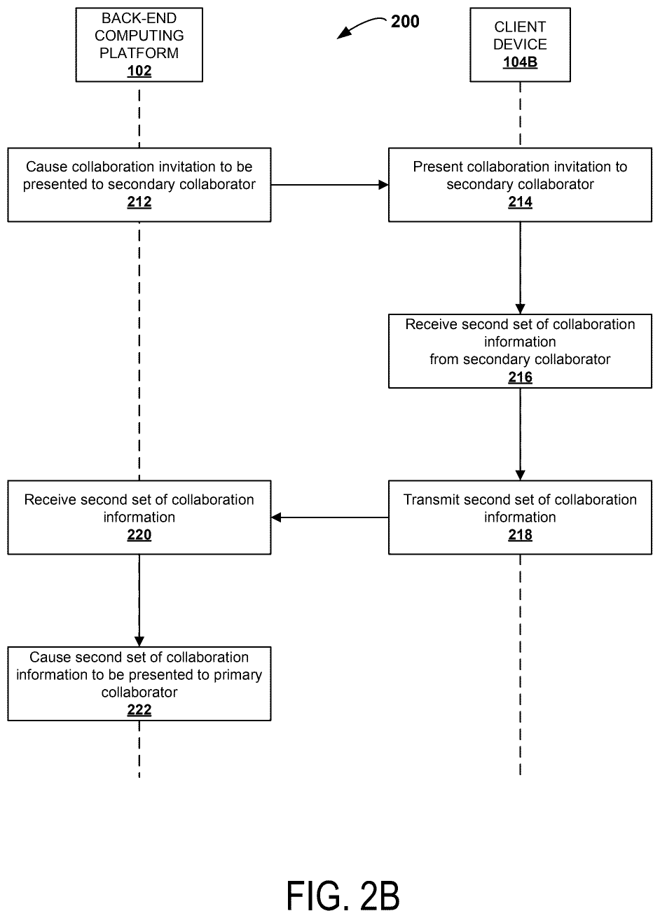

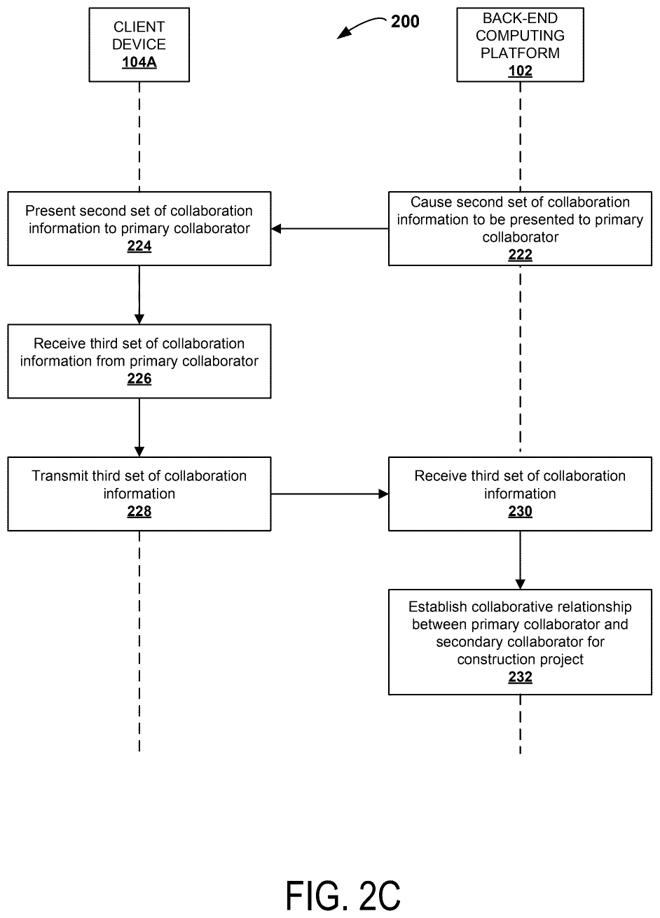

FIGS. 2A-2C each show a respective portion of a flow diagram 200 to illustrate possible examples of operations that may be carried out in accordance with the present disclosure for inviting a collaborator to collaborate on a construction project. For purposes of illustration only, the example functionality of FIGS. 2A-2C is described as being carried out within the example network environment of FIG. 1, with some operations being carried out by the client device 104A, other operations being carried out by the back-end computing platform 102, and still other operations being carried out by the client device 104B. It should be understood, however, that this example functionality may be carried out by any of various other devices in any of various other network environments as well. Further, it should be understood that the example functionality of FIGS. 2A-2C is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

Starting with FIG. 2A, the client device 104A may begin at block 202 by presenting an interface that enables a representative of the primary collaborator to create a collaboration invitation that invites a secondary collaborator to collaborate on a given construction project within a construction management software application. As used herein, this interface may be referred to as a “collaboration-invitation-creation interface,” and may be provided by the client device 104A while the client device 104A is running the construction management software application. For simplicity, it will be assumed that the functionality of the flow diagram 200 begins after an account of the primary collaborator has created with the construction management software application, as well as a project workspace for the given construction project.

The client device 104A may present the collaboration-invitation-creation interface based on receiving user input indicating a request to view the collaboration-invitation-creation interface. The user input may be received from a representative of the primary collaborator (e.g., who is authorized to create collaboration invitations). For instance, the representative of the primary collaborator may open the construction management software application, log in to the primary collaborator's account, and then select a selectable icon to open the collaboration-invitation-creation interface.

The client device 104A may present the collaboration-invitation-creation interface in any of various ways. As one possibility, the back-end computing platform 102 may cause the client device 104A to present the collaboration-invitation-creation interface, for instance, in implementations where the client device 104A is running front-end client software of the construction management software application and the back-end computing platform 102 is running back-end software of the construction management software application. In such implementations, the client device 104A may receive the user input indicating the request to view the collaboration-invitation-creation interface and then transmit an indication of the user input to the back-end computing platform 102, for instance, via the communication path 106. Then, the back-end computing platform 102 may (i) receive the indication of the user input, (ii) process the request to view the collaboration-invitation-creation interface, and then (iii) cause the client device 104A to present the collaboration-invitation-creation interface. To accomplish this, the back-end computing platform 102 may transmit a communication to the client device 104A that comprises instructions and data for constructing the collaboration-invitation-creation interface to the representative of the secondary collaborator. In practice, this communication may take the form of one or more response messages (e.g., one or more HTTP messages) that are sent over the communication path 106 between the back-end platform 102 and the client device 104A and in at least some implementations, the one or more messages may be sent via an API. However, the back-end computing platform's message may take other forms as well.

As another possibility, the client device 104A may present the collaboration-invitation-creation interface based on locally processing the request to view the collaboration-invitation-creation interface. Various other possibilities may also exist.

At block 204, the client device 104A may receive a first set of collaboration information from the primary collaborator (e.g., from a representative of the primary collaborator). For instance, the representative of the primary collaborator may interact with the collaboration-invitation-creation interface presented via the client device 104A running the construction management software application to input the first set of collaboration information. As described in greater detail below, the first set of collaboration information may be used by the back-end computing platform 102 to generate the collaboration invitation for the secondary collaborator.

The first set of collaboration information may include various types of collaboration information. One type of collaboration information that may be included in the first set of collaboration information may include information identifying the given construction project that the primary collaborator desires to invite the secondary collaborator to collaborate on. In practice, the primary collaborator may be involved in various construction projects, and the primary collaborator's account with the construction management software application may include a project workspace for each of the construction projects. To identify the given construction project that is the target of the collaboration invitation, the representative of the primary collaborator may select a selectable icon representing the given construction project, e.g., from a list of selectable icons that each represents a respective construction project that the primary collaborator is involved in. The list may be presented via the client device 104A running the construction management software application. As another option, the representative of the primary collaborator may input the information identifying the given construction project via a text field or the like that is presented via the client device 104A running the construction management software application.

Another type of collaboration information that may be included the first set of collaboration information may include information identifying the secondary collaborator. In practice, the information identifying the secondary collaborator may take any of various forms.

As one possibility, the information identifying the secondary collaborator may take the form of a name, email, phone number, address, and/or other identifying information of the secondary collaborator, which the representative of the primary collaborator may input via a text field or the like that is presented via the client device 104A running the construction management software application.

As another possibility, the information identifying the secondary collaborator may take the form of a user selection of a selectable icon that represents a candidate secondary collaborator that matches the name, email, phone number, address, etc. input by the representative of the primary collaborator. In some implementations, the information identifying the secondary collaborator may take this form when the secondary collaborator also has an account with the construction management software application. For instance, based on receiving the name, email, phone number, address, etc. input by the representative of the primary collaborator, the client device 104A may be configured to determine whether any party's account with the construction management software application matches the name, email, phone number, address, etc.

In practice, the client device 104A may accomplish this by transmitting a request to the back-end computing platform 102 including an indication of the name, email, phone number, address, etc. input by the representative of the primary collaborator, and receiving, from the back-end computing platform 102, a response that indicates one or more accounts of the construction management software application that match the name, email, phone number, address, etc. For instance, the back-end computing platform 102 may search one or more databases (either stored on the back-end computing platform 102 or remote to the back-end computing platform 102) that store information for accounts of the construction management software application to determine whether an account matches the name, email, phone number, address, etc. input by the representative of the primary collaborator. As another possibility, the client device 104A may determine whether an account of the construction management software application matches the input to the text field locally, e.g., without interacting with the back-end computing platform 102. The client device 104A may then present one or more selectable icons via the collaboration-invitation-creation interface, each corresponding to a candidate secondary collaborator that matches the name, email, phone number, address, etc. input by the representative of the primary collaborator. The primary collaborator may then select one of the selectable icons to identify the secondary collaborator.

Yet another type of collaboration information that may be included in the first set of collaboration information may include information identifying a universe of project roles that may be assigned to individuals associated with the secondary collaborator that are to be added as users to the project workspace of the given construction project. A project role may correspond to the type of responsibilities that a user with the project role may have regarding the given construction project. One example project role may be a “Project Manager,” and users assigned this role may be responsible performing tasks associated with managing the given construction project. Another example project role may be an “Invoice Contact,” and users assigned this role may be responsible for performing tasks associated with invoices, such as providing updates regarding invoices made throughout the lifetime of the given construction project, etc. Yet another example project role may be a “Laborer,” and users assigned this role may be responsible for various labor tasks, such as constructing portions of the given construction project, etc. Various other examples may also exist.

Yet another type of collaboration information that may be included in the first set of collaboration information may include information identifying one or more permission templates that are available for use in assigning permissions to the secondary collaborator's to-be-added users.

As one possibility, the first set of collaboration information may include a single permission template that is to be assigned to all users (e.g., all to-be-added users associated with the secondary collaborator and/or all to-be-added users associated with the primary collaborator). As another possibility, the first set of collaboration information may include multiple permission templates that each comprises a respective set of permissions. For instance, each permission template may comprise a respective set of permissions that corresponds to a respective project role in the universe of project roles. Various other possibilities may also exist.

In line with the previous discussion, each permission template defines a set of permissions with respect to the data objects and/or software features for the project workspace in terms of the types of data objects that can be accessed, the types of software features that can be utilized by the user, and/or the extent of access granted with respect to data object and/or software features (e.g., read/write access, read-only access, etc.). The permission templates may be identified in terms of numbers (e.g., “Template 1”, “Template 2”, “Template 3”, etc.,) or names (e.g., a “Project Manager” permission template, an “Invoice Contact” permission template, a “Laborer” permission template, etc.), among other possibilities.

In practice, the representative of the primary collaborator may identify the permission templates by selecting selectable icons for available permission templates from a dropdown menu or the like that is presented via the client device 104A running the construction management software application, wherein the dropdown menu includes a selectable icon for each available permission template. As another option, the representative of the primary collaborator may create a new permission template. Various other examples may also exist.

The first set of collaboration information may include various other types of collaboration information as well.

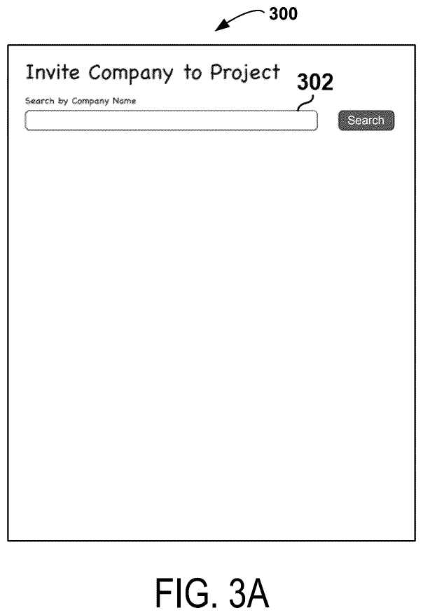

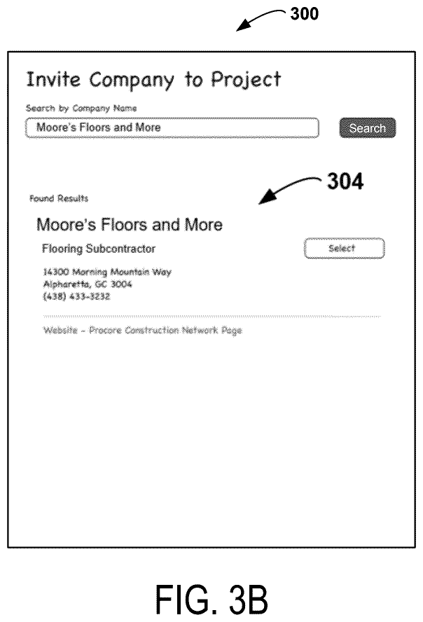

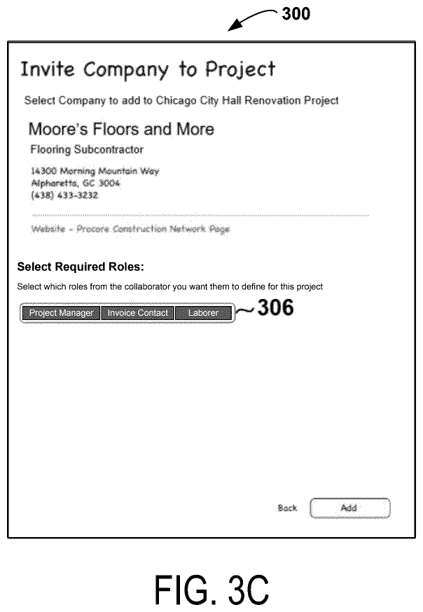

FIGS. 3A-3C are included to illustrate various aspects of the operations of blocks 202 and 204, and reference Steven's Structural Solutions, who may be the primary collaborator, Moore's Floors and More, who may be the secondary collaborator, and the Chicago City Hall Reconstruction project, in line with the example above.

Starting with FIG. 3A, an example interface 302 is shown, which may be an example of the collaboration-invitation-creation interface as previously described. For instance, in line with the previous discussion, Steven's Structural Solutions may have an account with the construction management software application that includes a project workspace for the Chicago City Hall Reconstruction project. A representative of Steven's Structural Solutions that is responsible for inviting collaborators on construction projects may log in to Steven's Structural Solutions' account via the client device 104A to navigate to the interface 300 for inviting Moore's Floors and More to collaborate on the Chicago City Hall Reconstruction project. As shown, the interface 300 includes a text field 302, which, in line with the previous discussion, may be populated with a name, email, phone number, address, etc. that identifies Moore's Floors and More.

As shown in FIG. 3B, the text field 302 has been populated with the name “Moore's Floors and More.” In line with the previous discussion, the client device 104A may determine that Moore's Floors and More has an account with the construction management software application. And, based on said determination, the client device 104A may present a selectable icon 304 that represents Moore's Floors and More. Although not shown, the client device 104A may present other selectable icons as well, which may represent other candidate secondary collaborators that match the name “Moore's Floors and More,” in line with the previous discussion.

FIG. 3C shows the interface 300 after the representative of Steven's Structural Solutions has (i) selected the selectable icon 304 and (ii) input a universe of project roles that may be assigned to the individuals associated with Moore's Floors and More that are to be added as users to the project workspace for the Chicago City Hall Reconstruction project. As shown, the interface 300 now includes a section 306 that has been populated with a universe of project roles input by the representative of Steven's Structural Solutions, including “Project Manager,” “Invoice Contact,” and Laborer.”

Although not shown, the representative of Steven's Structural Solutions may also identify one or more permission templates that are available for use in assigning permissions to the individuals associated with Moore's Floors and More that are to be added as users to the project workspace for the Chicago City Hall Reconstruction project. In some implementations, each of, the identified permission template(s) may correspond to a respective project role, e.g., there may be a respective permission template for each project role in the universe of project roles.

Returning to FIG. 2A, at block 206, the client device 104A may transmit the first set of collaboration information to the back-end computing platform 102 via the communication path 106. In practice, the communication containing the first set of collaboration information that is sent from the client device 104A may take the form of a request to create a collaboration invitation, although such communication may take other forms as well.

At block 208, the back-end computing platform 102 may receive the first set of collaboration information via the communication path 106 (e.g., as part of a request to create a collaboration invitation).

At block 210, the back-end computing platform 102 may generate a collaboration invitation based on the received first set of collaboration information. In line with the previous discussion, the first set of collaboration information may comprise the information to be included in the collaboration invitation, e.g., an identification of the given construction project, an identification of the secondary collaborator, and an identification of one or more permission templates that are available for use in assigning permissions to the individuals associated with the secondary collaborator that are to be added as users to the project workspace of the given construction project, among other possibilities previously discussed. For instance, based on receiving this first set of collaboration information, the back-end computing platform 102 may generate a data object that represents the collaboration invitation, which may contain data representing (i) the identification of the given construction project, (ii) the identification of the secondary collaborator, and/or (iii) the identification of one or more permission templates that are available for use in assigning permissions to the individuals associated with the secondary collaborator that are to be added as users to the project workspace of the given construction project, etc. The back-end computing platform 102 may store the data object that represents the collaboration invitation within the back-end computing platform 102, and the data object that represents the collaboration invitation may be accessible by representatives of the primary collaborator as well as by representatives of the secondary collaborator, as described in greater detail below.

At block 212, the back-end computing platform 102 may cause the collaboration invitation to be presented to the secondary collaborator identified in the collaboration invitation (e.g., presented to a representative of the secondary collaborator). To accomplish this, the back-end computing platform 102 may transmit a communication to the client device 104B that comprises instructions and data for constructing an interface that presents the collaboration invitation to the representative of the secondary collaborator. The interface that presents the collaboration invitation may be referred to herein as a “collaboration-invitation-viewing” interface. In practice, this communication may take the form of one or more response messages (e.g., one or more HTTP messages) that are sent over the communication path 106 between the back-end platform 102 and the client device 104B, and in at least some implementations, the one or more messages may be sent via an API. However, the back-end computing platform's message may take other forms as well.

In practice, the back-end computing platform 102 may cause the collaboration invitation to be presented to the secondary collaborator at various times, and in response to various trigger events. For instance, prior to causing the collaboration invitation to be presented to the secondary collaborator, the back-end computing platform 102 may cause a notification of the collaboration invitation to be presented to the secondary collaborator (e.g., presented to a representative of the secondary collaborator) via the client device 104B. As one example, the notification may be presented within an interface of the construction management software application. As another example, the notification may be presented as an alert that may be presented on a display of the client device 104B, e.g., regardless of whether or not the client device 104B is running the construction management software application. As yet another example, the notification may be presented as a link to the collaboration invitation that may be included in a text, email, or other form of communication that is transmitted to the client device 104B.

In any case, the back-end computing platform 102 may cause the collaboration invitation to be presented to the secondary collaborator based on a representative of the secondary collaborator interacting with the notification. For instance, based on detecting the interaction with the notification, the client device 104B may transmit a communication to the back-end computing platform 102 indicating the interaction with the notification, and the back-end computing platform 102 may cause the collaboration invitation to be presented to the secondary collaborator based on receiving the communication indicating the interaction with the notification from the client device 104B. Various other possibilities may exist.

Turning now to FIG. 2B, the flow diagram 200 is continued, picking up at block 212, which the back-end computing platform 102 may perform as previously described.

At block 214, the client device 104B may present the collaboration invitation to the secondary collaborator (e.g., to a representative of the secondary collaborator). In line with the previous discussion, the client device 104B may receive the communication transmitted by the back-end computing platform 102 that comprises the instructions and data for constructing the collaboration-invitation-viewing interface, and may utilize the instructions and data to present the collaboration-invitation-viewing interface. Various other possibilities may also exist.

At block 216, the client device 104B may receive a second set of collaboration information from the secondary collaborator (e.g., from a representative of the secondary collaborator) via the collaboration-invitation-viewing interface. For instance, the representative of the secondary collaborator may interact with the collaboration-invitation-viewing interface presented by the client device 104B running the construction management software application to input the second set of collaboration information.

The second set of collaboration information may include various types of collaboration information. One type of collaboration information that may be included in the second set of collaboration may include information indicating an acceptance or rejection of the collaboration invitation. For instance, the representative of the secondary collaborator may select an “accept invitation” selectable icon or the like presented via the client device 104B to accept the collaboration invitation, or a “decline invitation” selectable icon or the like presented via the client device 104B to reject the collaboration invitation.

Another type of collaboration information that may be included in the second set of collaboration information may include information indicating comments on the collaboration invitation. For instance, the representative of the secondary collaborator may include reasons why the collaboration invitation is being accepted or rejected, and may possibly request for adjustments to be made to the collaboration invitation (e.g., by requesting for different permission templates or different project roles to be assignable to individuals associate with the secondary collaborator that are to be added as users to the project workspace of the given construction project, etc.). In some implementations, a representative of the primary collaborator may revise and resend the collaboration invitation based on comments provided by the representative of the secondary collaborator.

Yet another type of collaboration information that may be included in the second set of collaboration information may include information identifying a project workspace within the account of the secondary collaborator (to the extent that such an account already exists at the time) that is to be connected to the primary collaborator's project workspace for the given construction project identified by the collaboration invitation. For example, a representative of the secondary collaborator may create a project workspace for the given construction project within the secondary collaborator's account and connect the created project workspace with the primary collaborator's project workspace for the given construction project. Various details regarding connecting project workspaces are included below.

Yet another type of collaboration information that may be included in the second set of collaboration information may include information identifying individuals associated with the secondary collaborator that are to be added as users to the project workspace of the given construction project. Information identifying an individual associated with the secondary collaborator that is to be added as a user to the project workspace of the given construction project may take any of various forms.

As one possibility, the information identifying an individual associated with the secondary collaborator that is to be added as a user to the project workspace of the given construction project may take the form of name or other identifying information of the individual, which the representative of the secondary collaborator may input via a text field or the like that is presented via the client device 104B running the construction management software application. In some implementations, the client device 104B may determine whether a user profile for the individual has been added to the account of the secondary collaborator. As one option, the client device 104A may accomplish this by transmitting a request to the back-end computing platform 102 including an indication of the name or other identifying information of the individual, as well as an indication of the account of the secondary collaborator, and receiving, from the back-end computing platform 102, a response that includes either (i) an indication of a user profile for the individual that has been added to the account of the secondary collaborator or (ii) an indication that no such user profile has been added to the account of the secondary collaborator. For instance, the back-end computing platform 102 may search one or more databases (either stored on the back-end computing platform 102 or remote to the back-end computing platform 102) that store information for the secondary collaborator's account to determine whether a user profile matching the name of other identifying information of the individual has been added to the account of the secondary collaborator. As another option, the client device 104A may determine whether a user profile matching the name of other identifying information of the individual has been added to the account of the secondary collaborator locally, e.g., without interacting with the back-end computing platform 102. In implementations where there is no matching user profile, the representative of the secondary collaborator may choose to create a new user profile for the individual and add the new user to the account of the secondary collaborator, after which the individual may be identified to be added to the project workspace of the given construction project.

As another possibility, the information identifying an individual associated with the secondary collaborator that is to be added as a user to the project workspace of the given construction project may take the form of a selection of a selectable icon that represents a user profile for the individual, e.g., which may have been added to the secondary collaborator's account. For instance, the client device 104B may determine the user profiles that have been added to the secondary collaborator's account and then present a list of selectable icons that each represents a respective user profile that has been added to the secondary collaborator's account. The representative of the secondary collaborator may then select a selectable icon from the list to identify the individual to be added as a user to the project workspace of the given construction project.

In some implementations (e.g., implementations where permissions for the to-be-added users are assigned based on a combination of permission templates identified by the primary collaborator and project roles for the to-be-added users), another type of collaboration information that may be included in the second set of collaboration information may include information identifying a respective project role for each of one or more of the individuals associated with the secondary collaborator that are to be added as users to the project workspace of the given construction project. For instance, the client device 104B may present, for each individual associated with the secondary collaborator that is to be added as a user to the project workspace of the given construction project, a respective dropdown menu or the like that includes a respective selectable icon for each project role in the universe of project roles. The secondary collaborator may then select a respective project role for each of one or more individuals associated with the secondary collaborator that are to be added as users to the project workspace of the given construction project. The input of project roles for the to-be-added users may take various other forms as well.

In other implementations (e.g., implementations where permissions for the to-be-added users are assigned based on the secondary collaborator's selection of a respective permission template for each to-be-added user from the one or more permission templates that were identified by the primary collaborator), another type of collaboration information that may be included in the second set of collaboration information may include information identifying a respective permission template for each to-be added user (or at least a subset there) that is selected from the one or more permission templates that were identified by the primary collaborator. For instance, the client device 104B may present, for each individual associated with the secondary collaborator that is to be added as a user to the project workspace of the given construction project, a respective dropdown menu or the like that includes a respective selectable icon for each permission template in the one or more permission templates identified by the primary collaborator. The secondary collaborator may then select, from the one or more permission templates identified by the primary collaborator as being available, a respective permission template for each of one or more individuals associated with the secondary collaborator that are to be added as users to the project workspace of the given construction project. The input of project roles for the to-be-added users may take various other forms as well.

In still other implementations (e.g., implementations where permissions for the to-be-added users are assigned based on the secondary collaborator's proposal of a respective project role for each to-be-added user that is not based on any previously-identified project role), a further type of collaboration information that may be included in the second set of collaboration information may include information identifying a respective proposed project role for each to-be added user (or at least a subset there). For instance, the client device 104B may present, for each individual associated with the secondary collaborator that is to be added as a user to the project workspace of the given construction project, a respective dropdown menu or the like that includes selectable icons for available project roles that the secondary collaborator may propose for the individual that have not been pre-identified by the primary collaborator. In some implementations, the project roles that are included in the dropdown menu or the like may not be included in the universe of project roles, but may nonetheless be defined or otherwise provided by the construction management software application. For example, a representative of the secondary collaborator may request for a project role that is associated with permissions for accessing certain data objects and/or software tools that may not otherwise be accessible using the permission templates identified by the primary collaborator.

The second set of collaboration information may include various other types of collaboration information as well.

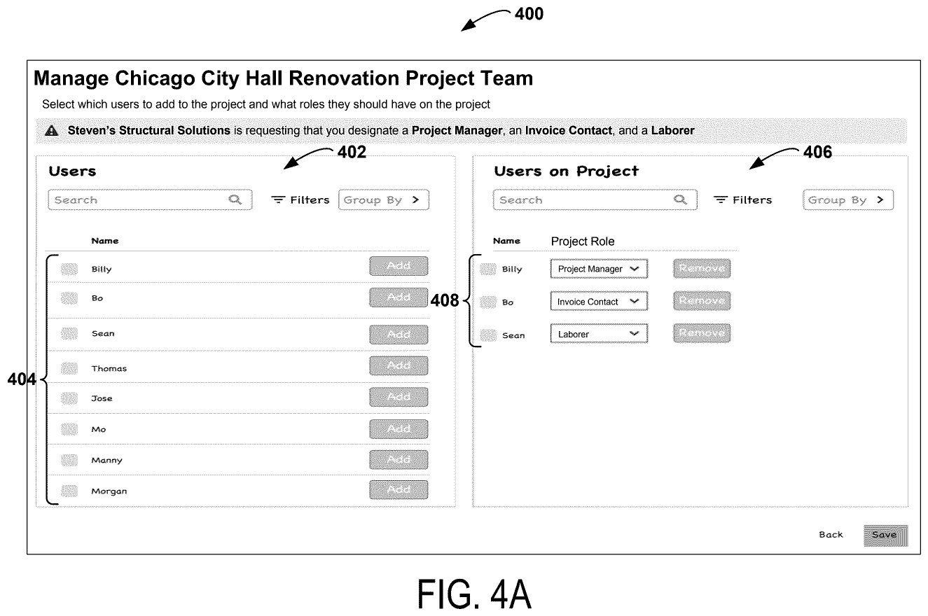

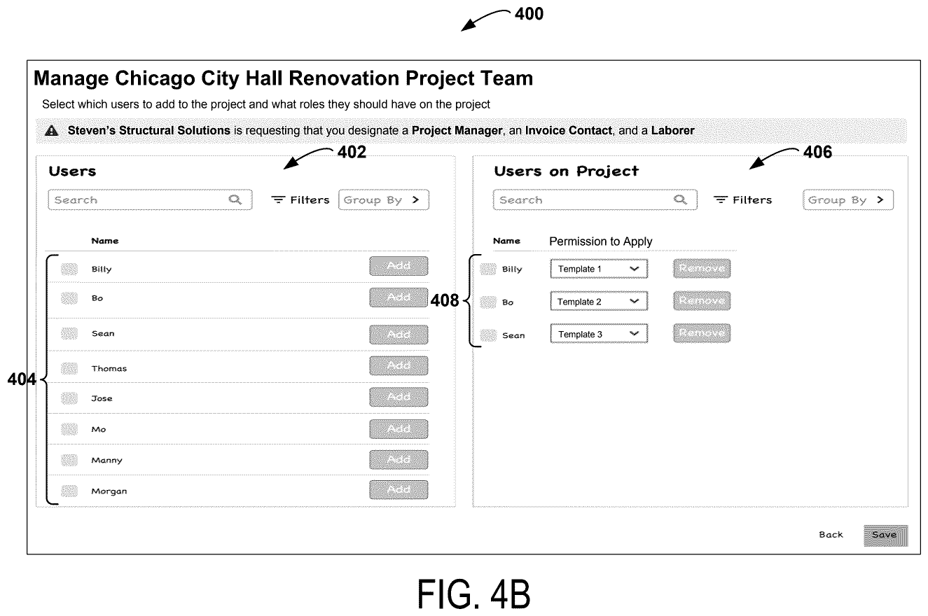

FIGS. 4A and 4B are included to illustrate various aspects of the operations of blocks 214 and 216, and references Steven's Structural Solutions, Moore's Floors and More, and the Chicago City Hall Reconstruction project mentioned in the examples above. Specifically, FIGS. 4A and 4B illustrate possible implementations where the first set of collaboration information includes information identifying one or more permission templates that are available to be assigned to users added to the project workspace, which may be used to assign permissions to the users.

Starting with FIG. 4A, a first example interface 400 is shown, which may be the collaboration-invitation-viewing interface previously discussed. For instance, in line with the previous discussion, a representative of Moore's Floors and More may select a notification presented via the client device 104B for the collaboration invitation, and based on said selection, the client device 104B may present the interface 400. As shown, the interface 400 includes a first section 402 for adding individuals associated with Moore's Floors and More's account to the project workspace of the given construction project. The first section 402 includes a list 404 that includes line items that each represents a respective user profile that has been added to Moore's Floors and More's account. A representative of Moore's Floors and More may select one or more of the user profiles from the list 404 to add to the project workspace for the given construction project.

Further, the interface 400 includes a second section 406 for assigning project roles to individuals associated with Moore's Floors and More that are to be added as users to the project workspace of the given construction project. As shown, the second section 406 includes a list 408 that includes line items that each represents an individual associated with Moore's Floors and More that has been selected to be added as a user to the project workspace for the given construction project. As shown, each line item includes (i) a name of a respective individual associated with Moore's Floors and More that has been selected to be added as a user to the project workspace for the given construction project and (ii) a dropdown menu for assigning a project role to the individual represented in the line item, among other things. As shown, Billy has been assigned the project role “Project Manager,” Bo has been assigned the project role “Invoice Contact,” and Sean has been assigned the project role “Laborer.” In line with the previous discussion, dropdown menus may enable the representative of Moore's Floors and More to assign project roles to the users (e.g., from the universe of project roles identified by Steven's Structural Solutions and included in the first set of collaboration information). Further, in the first example illustrated in FIG. 4A, the one or more permission templates identified by Steven's Structural Solutions and the assigned roles may be utilized by the platform 102 to automatically assign respective permission templates to Billy, Bo, and Sean.

FIG. 4B includes many of the same elements as FIG. 4A, with the exception that each line item of the list 408 now include a respective dropdown menu for selecting a respective permission template for the respective individual represented by the line item from the one or more permission templates identified by Steven's Structural Solutions. As shown, Billy has been associated with the permission template “Template 1,” Bo has been associated with the permission template “Template 2,” and Sean has been associated with the permission template “Template 3.” In line with the previous discussion, the dropdown menus may enable the representative of Moore's Floors and More to select permission templates from the one or more permission templates identified by Steven's Structural Solutions and included in the first set of collaboration information. Accordingly, in the example illustrated in FIG. 4B, permission templates may be assigned separately from project roles. Although not shown, in some implementations, the representative of Moore's Floors and More may be enabled to assign both permission templates and project roles (e.g., via respective dropdown menus).

Returning to FIG. 2B, at block 218, the client device 104B may transmit the second set of collaboration information to the back-end computing platform 102 via the communication path 106. In practice, the communication containing the second set of collaboration information that is sent from the client device 104A may take the form of a response to the collaboration invitation, although such communication may take other forms as well.

At block 220, the back-end computing platform 102 may receive the second set of collaboration information from the client device 104B via the communication path 106 (e.g., as part of a response to the collaboration invitation).

At block 222, the back-end computing platform 102 may cause the second set of collaboration information to be presented to the primary collaborator (e.g., presented to a representative of the primary collaborator). To accomplish this, the back-end computing platform 102 may transmit a communication to the client device 104A that comprises instructions and data for constructing an interface that presents the second set of collaboration information to the representative of the primary collaborator. The interface that presents the second set of collaboration information to the representative of the primary collaborator may be referred to herein as a “collaboration-invitation-reviewing” interface. In practice, this communication may take the form of one or more response messages (e.g., one or more HTTP messages) that are sent over the communication path 106 between the back-end platform 104 and the client device 104A, and in at least some implementations, the one or more messages may be sent via an API. However, the back-end computing platform's message may take other forms as well.

Turning now to FIG. 2C, the flow diagram 200 is continued, picking up at block 222, which the back-end computing platform 102 may perform as previously described.

At block 224, the client device 104A may present the second set of collaboration information to the primary collaborator (e.g., to a representative of the primary collaborator). In line with the previous discussion, the client device 104A may receive the communication transmitted by the back-end computing platform 102 that comprises the instructions and data for constructing the collaboration-invitation-reviewing interface that includes the second set of collaboration information, and may utilize the instructions and data to present the collaboration-invitation-reviewing interface.

At block 226, the client device 104A may receive a third set of collaboration information from the primary collaborator (e.g., from a representative of the primary collaborator) via the collaboration-invitation-reviewing interface. For instance, the representative of the primary collaborator may interact with the collaboration-invitation-reviewing interface presented via the client device 104A running the construction management software application to input the third set of collaboration information.

The third set of collaboration information may include various types of collaboration information, which may generally relate to an approval or adjustment to the secondary collaborator's response to the collaboration invitation.

One type of collaboration information that may be included in the third set of collaboration information may include information indicating a response-level approval or rejection of the secondary collaborator's response to the collaboration invitation. For instance, the representative of the primary collaborator may be able to accept or reject the secondary collaborator's response to the collaboration invitation with the selection of a single button, without needing to exhaustively review and approve/reject the users, project roles, and/or permission templates identified in the secondary collaborator's response to the collaboration invitation. In practice, this may often be the case when the primary collaborator has included only a single permission template in the first set of collaboration information, although this response-level approval or rejection may included in other situations as well.

Another type of collaboration information that may be included in the third set of collaboration information may include information indicating a response to the identified individuals associated with the secondary collaborator that are to be added as users to the project workspace of the given construction project. For instance, the representative of the primary collaborator may approve or reject the to-be-added users. Further, in some implementations, the representative of the primary collaborator may add additional individuals associated with the secondary collaborator as users to the project workspace of the given construction project.

In some implementations (e.g., implementations where permissions for the to-be-added users are assigned based on a combination of permission templates identified by the primary collaborator and project roles for the to-be-added users), another type of collaboration information that may be included in the third set of collaboration information may include information indicating a response to project role assignments to individuals associated with the secondary collaborator that are to be added as users to the project workspace of the given construction project. For instance, in implementations where the representative of the secondary collaborator inputs project roles that are to be used for assigning permissions, the representative of the primary collaborator may approve, reject, or modify the project role assignments (e.g., by assigning a project role for a given individual different from the project role indicated in the second set of collaboration information for the given individual).

In other implementations (e.g., implementations where permissions for the to-be-added users are assigned based on the secondary collaborator's selection of a respective permission template for each to-be-added user from the one or more permission templates that were identified by the primary collaborator), another type of collaboration information that may be included in the third set of collaboration information may include information indicating a response to permission template selections for individuals associated with the secondary collaborator that are to be added as users to the project workspace of the given construction project. For instance, in implementations where the representative of the secondary collaborator inputs permission template selections for the users from the one or more permission templates identified by the primary collaborator, the representative of the primary collaborator may approve, reject, or modify the permission template selections (e.g., by selecting a permission template for a given individual different from the permission template indicated in the second set of collaboration information for the given individual).

In still other implementations (e.g., implementations where permissions for the to-be-added users are assigned based on the secondary collaborator's proposal of a respective project role for each to-be-added user that is not based on any previously-identified project role), another type of collaboration information that may be included in the third set of collaboration information may include information indicating a response to project role proposals for individuals associated with the secondary collaborator that are to be added as users to the project workspace of the given construction project. For instance, in implementations where the representative of the secondary collaborator proposes project roles to potentially use for the users, the representative of the primary collaborator may review the proposed project roles and (i) approve, reject, or modify the proposed project roles, and (ii) apply permission templates, e.g., based on the proposed project roles.

In still further implementations (e.g., implementations where the primary collaborator does not identify permission templates in advance and the user permissions are not assigned based on input from the secondary collaborator), another type of collaboration information that may be included in the third set of collaboration information may include information indicating permission templates to be assigned to individuals associated with the secondary collaborator that are to be added as users to the project workspace of the given construction project. For instance, in implementations where the primary collaborator may not have previously identified any permission templates and the secondary collaborator did not propose any project roles from which to base permission templates, the representative of the primary collaborator may input a respective permission template for each to-be-added user, e.g., via a text field or dropdown menu or the like that is presented for each to-be-added user.

The third set of collaboration information may include various other types of collaboration information as well.

Further, in some implementations it may be possible that the representative of the primary collaborator may not provide any additional collaboration information at this stage of the process. For instance, in implementations where the first set of collaboration information includes one or more permission templates to use for assigning permissions to the to-be-added users and the one or more permission templates are used to assign the permissions to the to-be-added users, then there may not be a need for the representative of the primary collaborator to review and accept or reject the response to the collaboration invitation.

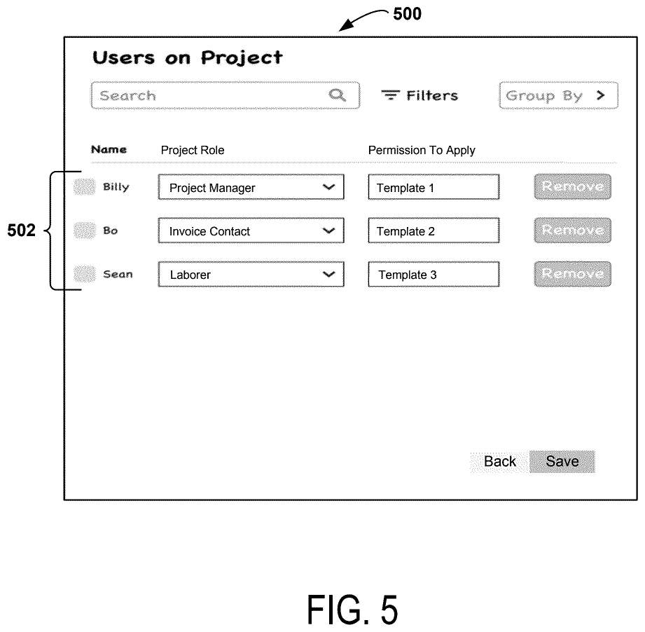

FIG. 5 is included to illustrate various aspects of the operations of blocks 224 and 226, and references Steven's Structural Solutions, Moore's Floors and More, and the Chicago City Hall Reconstruction project mentioned in the examples above. FIG. 5 shows an example interface 500, which may be the collaboration-invitation-reviewing interface previously discussed. For instance, in line with the previous discussion, the client device 104A may present the interface 500 based on receiving instructions and data for presenting the interface from the back-end computing platform 102.

As shown, the interface 500 includes a list 502 that includes line items that each represents an individual associated with Moore's Floors and More that has been selected to be added as a user to the project workspace for the given construction project. As shown, each line item includes (i) a name of a respective individual associated with Moore's Floors and More that has been selected to be added as a user to the project workspace for the given construction project (ii) a respective project role assigned to the individual represented by the line item, and (iii) a respective permission template assigned to the individual represented by the line item. For purposes of illustration, the permission-template fields are shown as being pre-prepopulated with permission templates that have been automatically assigned based on the assigned project roles, but as noted above, it is also possible for the permission templates to be assigned via user input from a representative of the primary collaborator and/or via prior user input from a representative of the secondary collaborator.

For example, Billy is shown to have a project role of “Project Manager,” which may be assigned by the representative of Moore's Floors and More and a permission template named “Template 1”, which may be automatically assigned based on the permission templates previously identified by Steven's Structural Solutions and Billy's assigned project role. As another example, Bo is shown to have a project role of “Invoice Contact,” which may be assigned by the representative of Moore's Floors and More, and a permission template named “Template 2”, which may be automatically assigned based on the permission templates previously identified by Steven's Structural Solutions and Bo's assigned project role. In line with the previous discussion, the representative of Steven's Structural Solutions may approve, reject, or modify aspects of the response to the collaboration invitation as represented in the line items of the list 502. For instance, the representative of Steven's Structural Solutions may approve Billy's assigned project role of “Project Manager,” but may modify Bo's assigned project role of “Invoice Contact” to “Laborer.” Various other possibilities may also exist.

Returning to FIG. 2C, at block 228, the client device 104A may transmit the third set of collaboration information to the back-end computing platform 102, e.g., via the communication path 106.

At block 230, the back-end computing platform 102 may optionally receive the third set of collaboration information from the client device 104A via the communication path 106.

At block 232, the back-end computing platform 102 may establish the collaborative relationship within the construction management software application between the primary collaborator and the secondary collaborator for the given construction project. For instance, the back-end computing platform 102 may add individuals associated with the secondary collaborator as users to the project workspace for the given construction project and thereby grant those users with access to the project workspace, and may assign permission templates to the added individuals based on the one or more permission templates identified by the primary collaborator via the collaboration-invitation-creation interface, user input from a representative of the secondary collaborator that is received via the collaboration-invitation-viewing interface (e.g., project roles, permission template selections, or permission template approvals), and/or user input from a representative of the primary collaborator that is received via the collaboration-invitation-reviewing interface, in line with the previous discussion. Once added to the project workspace of the given construction project, the added individuals may then be able to create, view, and interact with data objects stored within the project workspace for the given construction project according to their respective permissions.

In addition to the operations described with respect to the flow diagram 200, the new software technology may include various other features to facilitate the collaborative experience between the primary collaborator and the secondary collaborator.

As one example, in implementations where the secondary collaborator does not already have an account with the construction management software application, then the notification of the collaboration invitation previously described may further enable a representative of the secondary collaborator to create an account with the construction management software application for the secondary collaborator. For example, the notification may include a link that, when selected by the representative of the secondary collaborator, may direct the representative of the secondary collaborator to an interface for creating an account with the construction management software application for the secondary collaborator.

As another example, the new software technology may facilitate the collaborative relationship within the construction management software application between the primary collaborator and the secondary collaborator in various ways. As one possibility, individuals associated with the secondary collaborator that have been added as users to the project workspace of the given construction project may be able to directly access the data objects and software features within the project workspace of the given construction project stored within the primary collaborator's account. As another possibility, an instance of the project workspace of construction project may be created and stored within the secondary collaborator's account, and the individuals associated with the secondary collaborator that have been added as users to the project workspace of the given construction project may be able to access the instance of the project workspace of the given construction project as stored within the secondary collaborator's account. And in such instances, the back-end computing platform 102 may perform functionality for synchronizing the instance of the project workspace of the given construction project stored within the primary collaborator's account with the instance of the project workspace of the given construction project stored within the secondary collaborator's account (e.g., by copying changes to data within one project workspace instance to the other project workspace instance). Other possibilities may also exist.

As yet another example, various other interfaces of the construction management software application may be utilized by a representative of the primary collaborator to view and update outgoing collaboration invitations sent to other secondary collaborators, as well as to view and update established collaborative relationships with other secondary collaborators. For instance, the representative of the primary collaborator may manage collaborative relationships with multiple secondary collaborators, for one or more project workspaces. Managing these relationships may involve adding users, removing users, modifying project roles and/or permissions for users, and the like. One particular example may involve removing a secondary collaborator from the project workspace, e.g., when the collaborative relationship between the primary collaborator and secondary collaborator has ended. In some instances, this may involve replacing the old secondary collaborator with a new secondary collaborator, e.g., when work that was to be performed by the old secondary collaborator was incomplete. As a simple example of this, a general contractor may be dissatisfied with the work done by a roofing subcontractor, and may fire the roofing subcontract and hire a new roofing subcontractor to finish any incomplete work that the initial roofing subcontract was tasked with completing. Another particular example may involve removing a user associated with a secondary collaborator and replacing the user. For instance, the representative of the primary collaborator may have a negative experience working with a particular user associated with a secondary collaborator. The representative of the primary collaborator may (i) remove the particular user from the project workspace, and additionally (ii) prevent the particular user from being added to the project workspace again, as well as possibly other project workspaces owned by the primary collaborator.

As yet still another example, various other interfaces of the construction management software application may be utilized by a representative of the secondary collaborator to view and respond to incoming collaboration invitations sent by other primary collaborators, as well as to view and update established collaborative relationships with other primary collaborators. For instance, the representative of the secondary collaborator may request to add new members, to adjust project roles and/or permission templates for users, etc.

Further, in some implementations, a representative of a secondary collaborator may be able to request for one or more additional secondary collaborators to be added to the collaborative relationship for the given construction project. For instance, the secondary collaborator may suggest suppliers or the like to the primary collaborator, and the representative of the primary collaborator may invite the suggested collaborators to collaborate on the given construction project within the construction management software application in line with the discussion above.

Various other examples may also exist.

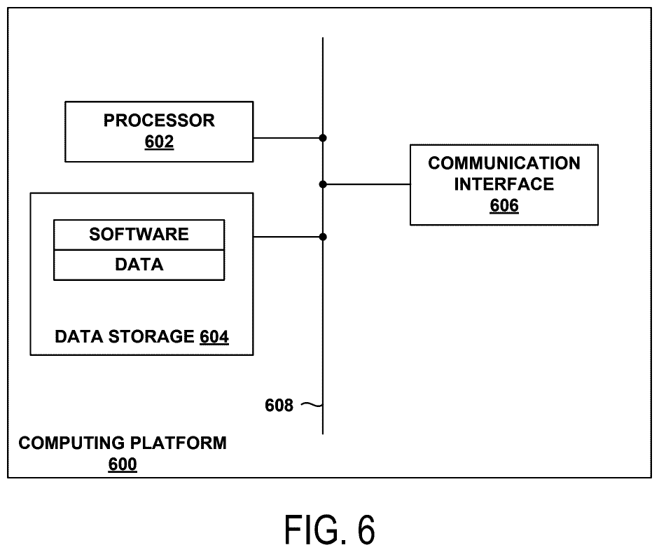

Turning now to FIG. 6, a simplified block diagram is provided to illustrate some structural components that may be included in an example computing platform 600 that may be configured to perform the platform-side functions disclosed herein. At a high level, the example computing platform 600 may generally comprise any one or more computer systems (e.g., one or more servers) that collectively include one or more processors 602, data storage 604, and one or more communication interfaces 606, each of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, the data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, the data storage 604 may be capable of storing both (i) program instructions that are executable by the one or more processors 602 such that the example computing platform 600 is configured to perform any of the various functions disclosed herein (including but not limited to any of the server-side functions discussed above), and (ii) data that may be received, derived, or otherwise stored by the example computing platform 600.

The one or more communication interfaces 606 may comprise one or more interfaces that facilitate communication between the example computing platform 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 600 may additionally have an Input/Output (I/O) interface that includes or provides connectivity to I/O components that facilitate user interaction with the example computing platform 600, such as a keyboard, a mouse, a trackpad, a display screen, a touch-sensitive interface, a stylus, a virtual-reality headset, and/or one or more speaker components, among other possibilities.

It should be understood that the example computing platform 600 is one example of a computing platform that may be used with the examples described herein. Numerous other arrangements are possible and contemplated herein. For instance, in other examples, the example computing platform 600 may include additional components not pictured and/or more or less of the pictured components.

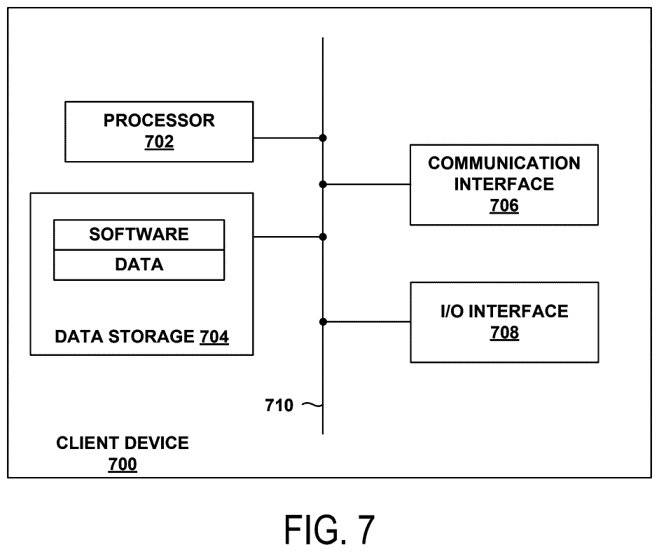

Turning next to FIG. 7, a simplified block diagram is provided to illustrate some structural components that may be included in an example client device 700 that may be configured to perform some the client-side functions disclosed herein. At a high level, the example client device 700 may include one or more processors 702, data storage 704, one or more communication interfaces 706, and an I/O interface 708, each of which may be communicatively linked by a communication link 710 that may take the form a system bus and/or some other connection mechanism. Each of these components may take various forms.

For instance, the one or more processors 702 of the example client device 700 may comprise one or more processor components, such as one or more CPUs, GPUs, ASICs, DSPs, and/or programmable logic devices such as FPGAs, among other possible types of processing components.

In turn, the data storage 704 of the example client device 700 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 7, the data storage 704 may be capable of storing both (i) program instructions that are executable by the one or more processors 702 of the example client device 700 such that the example client device 700 is configured to perform any of the various functions disclosed herein (including but not limited to any of the client-side functions discussed above), and (ii) data that may be received, derived, or otherwise stored by the example client device 700.

The one or more communication interfaces 706 may comprise one or more interfaces that facilitate communication between the example client device 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 708 may generally take the form of (i) one or more input interfaces that are configured to receive and/or capture information at the example client device 700 and (ii) one or more output interfaces that are configured to output information from the example client device 700 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 708 may include or provide connectivity to output components such as a display screen and/or an audio speaker, among other possibilities.

It should be understood that the example client device 700 is one example of a client device that may be used with the examples described herein. Numerous other arrangements are possible and contemplated herein. For instance, in other examples, the example client device 700 may include additional components not pictured and/or more or fewer of the pictured components.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that are executable by the at least one processor such that the computing platform is configured to:
receive, from a primary collaborator, a request to create an invitation for a secondary collaborator to collaborate on a construction project within a construction management software application, wherein the primary collaborator has created a project workspace for the construction project within the construction management software application, and wherein the request to create the invitation includes a first set of collaboration information comprising at least (i) an identification of the secondary collaborator and (ii) an identification of one or more permission templates that are available for assignment to users associated with the secondary collaborator;
based on the received request, cause the invitation to be presented to the secondary collaborator;
receive, from the secondary collaborator, a response to the invitation to collaborate on the construction project within the construction management software application, wherein the response to the invitation includes a second set of collaboration information comprising at least an identification of one or more users associated with the secondary collaborator that are to be granted access to the project workspace for the construction project; and
based on the first set of collaboration information and the second set of collaboration information, enable each of the identified one or more users associated with the secondary collaborator to access the project workspace in accordance with a respective permission template that is selected from the one or more permission templates identified by the first collaborator.

2. The computing platform of claim 1, wherein the second set of collaboration information further comprises, for each of the one or more identified users associated with the secondary collaborator that are to be granted access to the project workspace, an identification of a respective permission template for the identified user that is selected by the secondary collaborator from the one or more permission templates.

3. The computing platform of claim 1, wherein the program instructions that are executable by the at least one processor such that the computing platform is configured to enable each of the identified one or more users associated with the secondary collaborator to access the project workspace in accordance with the respective permission template that is selected from the one or more permission templates identified by the first collaborator comprise program instructions stored on the at least one non-transitory computer-readable medium that are executable by the at least one processor such that the computing platform is configured to:
assign each of the identified one or more users associated with the secondary collaborator the respective permission template for the identified user that is selected by the secondary collaborator from the one or more permission templates.

4. The computing platform of claim 1, wherein the first set of collaboration information further comprises a universe of project roles that are available for assignment to users associated with the secondary collaborator.

5. The computing platform of claim 4, wherein the one or more permission templates are each associated with a respective project role.

6. The computing platform of claim 5, wherein the second set of collaboration information further comprises, for each of the one or more identified users associated with the secondary collaborator that are to be granted access to the project workspace, an identification of a respective project role of the identified user that is input by the secondary collaborator.

7. The computing platform of claim 1, wherein the program instructions that are executable by the at least one processor such that the computing platform is configured to enable each of the identified one or more users associated with the secondary collaborator to access the project workspace in accordance with the respective permission template that is selected from the one or more permission templates identified by the first collaborator comprise program instructions stored on the at least one non-transitory computer-readable medium that are executable by the at least one processor such that the computing platform is configured to:
assign each of the identified one or more users associated with the secondary collaborator a respective permission template from the one or more permission templates that is associated with respective project role of the identified user that is input by the secondary collaborator.

8. The computing platform of claim 1, further comprising program instructions stored on the at least one non-transitory computer-readable medium that are executable by the at least one processor such that the computing platform is configured to:
receive, from the primary collaborator, a third set of collaboration information comprising an approval, rejection, or modification of the response to the invitation to collaborate on the construction project.

9. The computing platform of claim 1, wherein each permission template of the one or more permission templates defines a respective extent of access to types of data objects and software features for the project workspace.

10. A non-transitory computer-readable medium, wherein the non-transitory computer-readable medium is provisioned with program instructions that, when executed by at least one processor, cause a computing platform to:
receive, from a primary collaborator, a request to create an invitation for a secondary collaborator to collaborate on a construction project within a construction management software application, wherein the primary collaborator has created a project workspace for the construction project within the construction management software application, and wherein the request to create the invitation includes a first set of collaboration information comprising at least (i) an identification of the secondary collaborator and (ii) an identification of one or more permission templates that are available for assignment to users associated with the secondary collaborator;
based on the received request, cause the invitation to be presented to the secondary collaborator;
receive, from the secondary collaborator, a response to the invitation to collaborate on the construction project within the construction management software application, wherein the response to the invitation includes a second set of collaboration information comprising at least an identification of one or more users associated with the secondary collaborator that are to be granted access to the project workspace for the construction project; and
based on the first set of collaboration information and the second set of collaboration information, enable each of the identified one or more users associated with the secondary collaborator to access the project workspace in accordance with a respective permission template that is selected from the one or more permission templates identified by the first collaborator.

11. The non-transitory computer-readable medium of claim 10, wherein the second set of collaboration information further comprises, for each of the one or more identified users associated with the secondary collaborator that are to be granted access to the project workspace, an identification of a respective permission template for the identified user that is selected by the secondary collaborator from the one or more permission templates.

12. The non-transitory computer-readable medium of claim 10, wherein the program instructions that, when executed by at least one processor, cause the computing platform to enable each of the identified one or more users associated with the secondary collaborator to access the project workspace in accordance with the respective permission template that is selected from the one or more permission templates identified by the first collaborator comprise program instructions that, when executed by at least one processor, cause the computing platform to:
assign each of the identified one or more users associated with the secondary collaborator the respective permission template for the identified user that is selected by the secondary collaborator from the one or more permission templates.

13. The non-transitory computer-readable medium of claim 10, wherein the first set of collaboration information further comprises a universe of project roles that are available for assignment to users associated with the secondary collaborator.

14. The non-transitory computer-readable medium of claim 13, wherein the one or more permission templates are each associated with a respective project role.

15. The non-transitory computer-readable medium of claim 14, wherein the second set of collaboration information further comprises, for each of the one or more identified users associated with the secondary collaborator that are to be granted access to the project workspace, an identification of a respective project role of the identified user that is input by the secondary collaborator.

16. The non-transitory computer-readable medium of claim 10, wherein the program instructions that, when executed by at least one processor, cause the computing platform to enable each of the identified one or more users associated with the secondary collaborator to access the project workspace in accordance with the respective permission template that is selected from the one or more permission templates identified by the first collaborator comprise program instructions that, when executed by at least one processor, cause the computing platform to:
assign each of the identified one or more users associated with the secondary collaborator a respective permission template from the one or more permission templates that is associated with respective project role of the identified user that is input by the secondary collaborator.

17. The non-transitory computer-readable medium of claim 10, wherein the non-transitory computer-readable medium is also provisioned with program instructions that, when executed by at least one processor, cause the computing platform to:
receive, from the primary collaborator, a third set of collaboration information comprising an approval, rejection, or modification of the response to the invitation to collaborate on the construction project.

18. The non-transitory computer-readable medium of claim 10, wherein each permission template of the one or more permission templates defines a respective extent of access to types of data objects and software features for the project workspace.

19. A method implemented by a computing platform, the method comprising:
receiving, from a primary collaborator, a request to create an invitation for a secondary collaborator to collaborate on a construction project within a construction management software application, wherein the primary collaborator has created a project workspace for the construction project within the construction management software application, and wherein the request to create the invitation includes a first set of collaboration information comprising at least (i) an identification of the secondary collaborator and (ii) an identification of one or more permission templates that are available for assignment to users associated with the secondary collaborator;
based on the received request, causing the invitation to be presented to the secondary collaborator;
receiving, from the secondary collaborator, a response to the invitation to collaborate on the construction project within the construction management software application, wherein the response to the invitation includes a second set of collaboration information comprising at least an identification of one or more users associated with the secondary collaborator that are to be granted access to the project workspace for the construction project; and
based on the first set of collaboration information and the second set of collaboration information, enabling each of the identified one or more users associated with the secondary collaborator to access the project workspace in accordance with a respective permission template that is selected from the one or more permission templates identified by the first collaborator.

20. The method of claim 19, wherein the second set of collaboration information further comprises, for each of the one or more identified users associated with the secondary collaborator that are to be granted access to the project workspace, an identification of a respective permission template for the identified user that is selected by the secondary collaborator from the one or more permission templates.
